(19) United States
(12) Patent Application Publication
(10) Pub. No.: US 2017/0157519 A1
(43) Pub. Date: Jun. 8, 2017

(54) GAME DEVICE, CONTROL MECHANISM OF THE GAME DEVICE AND STORING MEDIA

(71) Applicant: CAPCOM CO., LTD., Osaka (JP)

(72) Inventors: Junhiro NISHIYAMA, Osaka (JP); Ryuhei ANDO, Osaka (JP)

(73) Assignee: CAPCOM CO., LTD., Osaka (JP)

(21) Appl. No.: 15/324,069

(22) PCT Filed: Mar. 18, 2015
(86) PCT No.: PCT/JP2015/058038

§ 371 Date: Jan. 5, 2017

(30) Foreign Application Priority Data
Jul. 9, 2014 (JP) 2014-141134

(51) Int. Cl. A63F 13/87; A63F 13/35

(52) U.S. Cl. CPC A63F 13/87; A63F 13/35

(57) ABSTRACT

A game system including a server device connected to a network and one or more terminal devices operated by users and executing a video game that a player character plays a quest in a game space which has a quest data storing unit which stores quest data, a playing status storing unit which stores playing status of the quest, a quest control unit which permits the start of the quest, and a hint control unit which notifies the information for the starting conditions. The playing status storing unit acquires the playing status from the quest control unit and updates the playing status, and the hint control unit determines the information for the starting conditions based on the playing status.

### TECHNICAL FIELD

The present invention relates to a technology which displays a message in a game.

### BACKGROUND OF THE INVENTION

A game with a multiple-play system which can be played by operating each of a play characters in the same game space by a multiple of users has been well known.

Over the years, a game which enables a multiple-play through the internet from distant spots has been pervading.

In the game which enables the multiple-play through the internet, a chat feature is equipped in order to communicate between the users.

For example, there is a possibility for the user to send out a message to the other users when one of a player character of such users are in a desperate situation such as the player is in a sleeping status and need a help from the other users.

However, there is a possibility that the users may not be able to send the message to the other users since the users need to operate the game in order to overcome the confronting desperate situation as a priority.

As another example, the users may send out the message to the other users when there is a possibility that the other users may be brought into a situation due to the users' action or when the users do not want to be disturbed by the other users .

However, the user may not be able to send out or may forget to send out the message.

### SUMMARY OF INVENTION

The disclosure was made in view of the above and is intended to let the users communicate more accurately about their player character with the other users.

A game device related to the disclosure includes:

a display unit displaying the game screen,
an operation unit inputting the operation of the users,
a storing unit storing the data,
a virtual space generation unit generating the virtual game space: and
controlling within the game space a first player character based on the operation information inputted by the user using the operation unit,
and receiving the control information of a second player character operated by the other users,
a player character control unit which controls the second player character within the game space,
a message reserving unit containing predetermined conditions and messages by associating them to each other and storing them into the storing unit.
a judgement unit determining whether the predetermined conditions are met,
to retrieve the message associated to the predetermined conditions from the storing unit when the judgement unit determines that the predetermined conditions have been met,
a message sending unit sending messages to the other users,
a message displaying unit displaying the message sent out by the message sending unit and the message received by the other users.

According to the present invention, the predetermined conditions and the messages are associated to each other and stored in the storing unit and may be able to communicate more accurately about their player character's status to the other users when the predetermined conditions are met, by having a message sending unit send the message related to the predetermined conditions to the other users.

### BRIEF DESCRIPTION OF THE DRAWINGS

FIG. 1 is a block diagram of a hardware configuration illustrating a configuration of a game console which executes a game program relating to a description of embodiment.

FIG. 2 is a diagram illustrating an example of a game screen during an online multiplayer game.

FIG. 3 is a diagram illustrating an example of the game screen selecting a fixed phrase.

FIG. 4 is a diagram illustrating an example of the game screen setting the fixed phrase sent out automatically.

FIG. 5 is a functional block diagram illustrating the configuration of the game device configured by the game program in the description of embodiment.

FIG. 6 is a flowchart illustrating a process flow for automatically sending out the fixed phrase when sending out conditions have been met.

### DESCRIPTION OF EMBODIMENTS

The description of embodiment for the present invention is explained by using the figures, as follows.

(Configuration of Hardware)

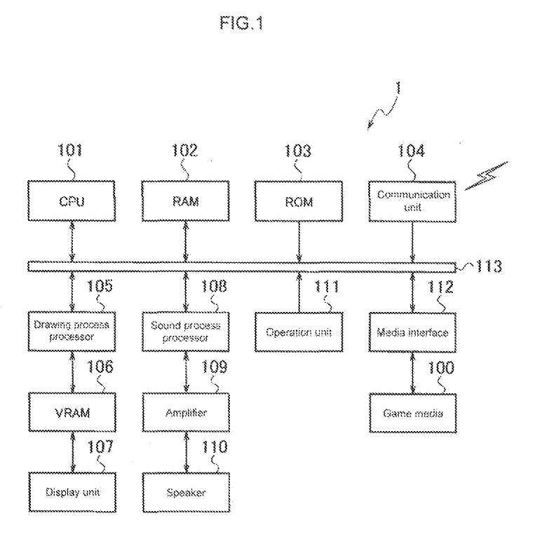

The game console 1 executing the game program regarding the description of embodiment is explained by referring to FIG. 1.

The game console 1 is a general game device with a CPU (Central Processing Unit) 101, a RAM (Random Access Memory) 102, a ROM (Read Only Memory) 103, a communication unit 104, drawing process processer 105, a VRAM (Video RAM) 106, a display unit 107, a sound process processor 108, an amplifier 109, a speaker 110, an operation unit 111, a media interface 112, and a bus 113.

The game program including instructions for the game console 1 to follow the instructions is stored in game media 100 which is a non-transitory storing media.

The game program may be executed on any kind of device as long as it is a computer with a CPU or a memory.

The CPU 101, the RAM 102, the ROM 103, the communication unit 104, the drawing process processer 105, the sound process processor 108, the operation unit 111, and the media interface 112 are connected to enable a data transmission to each other by bus 113.

The CPU 101 executes by reading the game program from the game media 100 which is connected to the media interface 112 on to the RAM 102, and controls the progress of the game by utilizing the hardware function in the game console 1.

The RAM 102 stores every kind of data such as the game program and the game data.

The ROM 103 stores a system program which achieves activation or basic functions of the game console 1.

The communication unit 104 sends and receives the data between external devices such as other game consoles or servers by wired or wireless communications.

The communication unit 104 may receive the game program from the server and store the game program in the game media 100.

The drawing process processer 105 write into the VRAM 106 the game screen displayed on the display unit 107, according to the progress of the game by following the instructions from the CPU 101.

The display unit 107 has a display means such as a liquid crystal display device which displays by reading out the game screen on the VRAM 106.

The sound process processor 108 processes a sound effects or BGM according to the progress of the game by following the instructions from the CPU 101.

The sound effects or the BGM processed by the sound process processor 108 is output from the speaker 110 by amplified by the amplifier 109.

The operation unit 111 has an input means such as an operation button or a touch panel, and the users' operation input thereto.

The CPU 101 controls the player character based on the users' operation information which was input by the operation unit 111.

(Details of the Game)

The game provided by the game program in the description of embodiment is explained, as follows.

The game is a hunting game which is played by the users operating the player character and to hunt monsters existing within a virtual game space.

In the game, a communication is made between the game console 1 operated by other users by connecting the game console 1 to a network.

It is possible to play the online multiplayer game within the same virtual game space with the other users at the same time in the game.

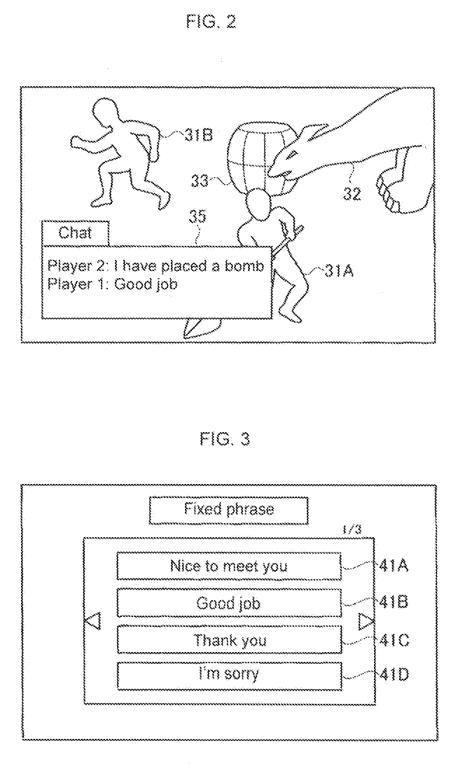

An example of the game screen during the online multiplayer game is illustrated in FIG. 2.

In a player character 31A which is operated by the users, a player character 31B operated by the other users, a monster 32, a bomb 33, and a chat field 35 are displayed in the game screen illustrated in FIG. 2

The player character 31A and the player character 31B cooperate with each other upon defeating the monster 32.

The game has a chat function and the users can input the messages which they want to deliver to the other users during the online play into the chat filed 35.

In FIG. 2, the player character 31B is delivering a massage on the chat field 35 about setting the bomb 33 and the player character 31A is sending a message evaluating the player character 31B's action.

The chat field 35 is not always displayed but displayed only for a predetermined time when either of the users communicate.

The chat function may be used when the player character is in its base or during a quest in the game.

The users may send a sentence by freely making one using a software keyboard where letters are arranged when the users are in their base.

The users may send a message prepared in advance as a fixed phrase during the quest.

The messages sent out are received by the other users' game console 1 and the name of a speaker is displayed on the chat field 35.

The fixed phrase may be sent out from the base or by preparing the sentence by using the software keyboard during the quest.

The game console 1 receives the message “I have placed a bomb” from a player 2 and it is displayed on the chat field 35 as “the player 2: I have placed a bomb” in FIG. 2.

The game console 1 also displays the message sent by a player 1 himself/herself on the chat field 35 as “the player 1: good job”.

(Chat Function Using the Fixed Phrase)

The chat function using the fixed phrase is explained as follows.

There are ways such as selecting the fixed phrase from the fixed phrase set up in advance or the ways to automatically send the corresponding fixed phrase when the sending out conditions have been met by applying the predetermined sending out conditions to the fixed phrase in the chat function using the fixed phrase.

The way to select the fixed phrase is explained, as follows.

An example of the game screen selecting the fixed phrase is illustrated in FIG. 3.

The game screen in FIG. 3 is displayed by the users either selecting an item for the chat from the menu or operating a predetermined operation button.

Four fixed phrases 41A˜41D are displayed in the example of FIG. 3.

The selected fixed phrases are sent to the other users' game console 1 by the users selecting one phrase from 41A˜41D.

In the game, it is possible to select twelve different fixed phrases by switching and displaying the game screen for three pages.

The users may freely edit the fixed phrases and input them in the game.

When the game console 1 has two screens, the virtual game space is displayed on the one screen and the game screen to select the fixed phrase is displayed on the other screen.

By doing this, the game screen to select the fixed phrase will not get in the way of playing the game.

If there is a touch panel on the screen, the fixed phrase is selected by touching the fixed phrase displayed.

The way to automatically send the fixed phrase is explained, as follows.

The game console 1 automatically sends the corresponding fixed phrase when meeting the predetermined sending out conditions.

Therefore the users need not operate to select the fixed phrase sending to the other users.

The users relate the sending out conditions and the fixed phrase in advance.

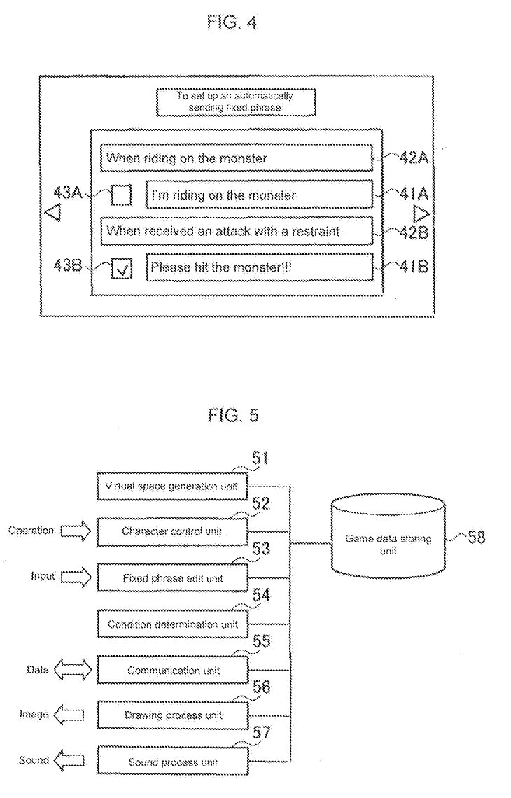

An example of the game screen setting the fixed phrase sent out automatically is illustrated in FIG. 4.

The fixed phrases 41A and 41B illustrated in FIG. 4 correspond to the sending out conditions 42A and 42B respectively.

The sending out conditions 42A and 42B are set in advance.

The users cannot change the sending out conditions 42A and 42B.

It is possible to set the two sending out conditions 41A and 41B at the same time in the game screen illustrated in FIG. 4.

It is possible for the users to set other sending out conditions by switching the page in the game screen.

The users may set whether to send the fixed phrase 41A and 41B automatically or not by a check box 43A and 43B when the sending out conditions 42A and 42B are met.

When there is no check on either of the check box 43A and 43B, the fixed phrase 41A and 41B are not sent out even when the sending out conditions 42A and 42B are met.

In the example as illustrated in FIG. 4, the fixed phrase 41A is not sent out even if the sending condition 42A is met, since there is no check in the check box 43A.

The fixed phrase 41B will be sent if the sending condition 42B is met, since the check box 43B is checked.

The users may freely edit the fixed phrases 41A and 41B.

(The Game Device)

The game device established by the game console executing the game program in the description of embodiment will be explained as follows.

FIG. 5 is a functional block diagram illustrating the configuration of the game device established by the game program in the description of embodiment.

The game device illustrated in FIG. 5 has a virtual space generating unit 51, a character control unit 52, a fixed phrase edit unit 53, a condition determination unit 54, a communication unit 55, a drawing process unit 56, a sound process unit 57, and a game data storing unit 58.

The virtual space generating unit 51 generates virtual game space where the player character or the monsters acts.

The character control unit 52 receives the users' operation and controls the player character according to the operation as well as an NPC (non-payer character) such as the monsters.

During the online multiplayer game, the character control unit 52 receives control information of the other player character which is operated by the other users' operation and controls the other player character.

The fixed phrase edit unit 53 receives the settings of the fixed phrase which is automatically sent according to the sending out conditions, and stores them in the game data storing unit 58.

The game data storing unit 58 stores by associating the sending out conditions, the fixed phrase, and information indicating whether to send automatically or not.

The fixed phrase edit unit 53 stores the edited fixed phrase in the game data storing unit 58 when the users edited the fixed phrase.

The condition determination unit 54 decides whether or not the sending out conditions have been met, and if the sending out conditions are met, reads the corresponding fixed phrase from the game data storing unit 58 and sends them to the other users' game device as well as display the corresponding fixed phrase on the chat field of its own game device.

The communication unit 55 sends and receives information indicating the action or the status of the player character or the NPC during the online multiplayer game, or the fixed phrase displayed on the chat field, between the other game devices.

The drawing process unit 56 generates an image by rendering the virtual game play space generated by virtual space generating unit 51, the player character, the NPC, etc.

The drawing process unit 56 outputs the image by adding the fixed phrase on the chat field for either of the following (1)˜(3) cases.

(1) When receiving the fixed phrase from the other users.
(2) When the users select the fixed phrase.
(3) When the condition determination unit 54 sends out the fixed phrase according to the sending out conditions.

The sound process unit 57 outputs the sound effect, BGM, and sound such as sound of crying according to the progress of the game.

The game data storing unit 58 stores necessary data for the progress of the game such as modeling data or texture data to produce the virtual game space, the player character, the modeling data or the texture data for the NPC or the like, sound effect data, and BGM data.

The game data storing unit 58 uses the RAM 102 of the game console 1 as the storing unit, and stores the content of the fixed phrase and the settings for the fixed phrase automatically sent out.

(Movement)

The process for automatically sending the fixed phrase when the sending out conditions are met will be explained, as follows.

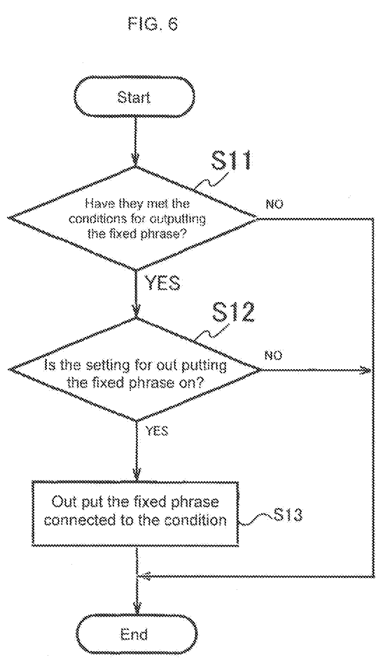

FIG. 6 is a flowchart illustrating a process flow for automatically sending out the fixed phrase when the sending out conditions have been met.

First of all, the condition determination unit 54 determines whether or not the sending out conditions have been met (step S11).

The game device ends the process of FIG. 6 when the sending out conditions are not met (NO under Step S11).

The condition determination unit 54 determines whether the settings for sending the fixed phrase automatically are on or off (Step S12) if the sending out conditions have been met (YES under Step S11).

If there is a check on the check box 43A and 43B as illustrated in FIG. 4, the settings for sending the fixed phrase automatically are on and if it is not checked on the check box, the settings for sending the fixed phrase automatically are off.

The game device ends the process of FIG. 6 when the settings for sending the fixed phrase automatically are off (NO under Step S12).

If the settings for sending the fixed phrase automatically are on (YES under Step S12), the condition determination unit 54 reads the fixed phrase related to the sending out conditions from game data storing unit 58, the communication unit 55 sends the fixed phrase to the game device operated by the other users, and the drawing process unit 56 displays the fixed phrase on the chat field (Step S13).

The messages such as the fixed phrase may be sent and received directly between the player's game device connected by a P2P (Peer to Peer) and other game device or may be sent and received through a server device.

The messages may be sent to a multiple other game devices.

(Examples of the Sending out Conditions)

A specific example of the sending out conditions is explained as follows.
The sending out condition “When the player character rides on the monster”
Default fixed phrase “I'm riding on the monster”.

In the game, if the player character delivers jumping attack (attacking after making a jump) to a specific portion of the monster for the predetermined number of times, the player character jumps on the monster (a riding status).

If the player character delivers a predetermined damaging blow to the monster during the “riding status”, the monster will not be able to move for a while and this becomes a chance to attack.

However, if the monster is attacked by the other player character during the “riding status” and if the monster winces, the “riding status” will be released.

The users may contain the other users attacking the monster by notifying the other users of their own player character riding on the monster.

The sending out condition “When the player character received an attack with restraint”.
Default fixed phrase “Restrained!”

In the game the monster may attack the player character with restraint.

The restraint may be release by the user operating a movable button quickly to left and right when the player character received the attack with restraint.

However, if the users are unable to release the restraint within the predetermined time, the player character will receive a huge damage at the end of the restraint.

The users may expect backup from the other users by notifying the other users of the users' player character receiving the attack with restraint since the restraint will be released when the other player character attack the monster and the monster winces against such attacker.
The sending out condition “When the player character enters into a snowman status/sleeping status”
Default fixed phrase “Crisis!!”

In the game, the player character cannot move when it enters into the snowman status or the sleeping status.

The player character may recover from the snowman status or the sleeping status by receiving attack from the other player character.

Therefore, the users may expect the other player character to attack the users' player character by notifying the other user of the users' player character entering into the snowman status or the sleeping status.
The sending out condition “When the player character sets a bomb”
Default fixed phrase “A bomb has been set”In the game, the other character could also be caught up in a bomb explosion set by the player character.

The users may avoid the other player character to be involved in the bomb explosion by notifying the other user of setting the bomb.
The sending out condition “When the player character passed out/in a dizzy status”.
Default fixed phrase “staggering . . . ”

In the game, the player character cannot move when it passes out or in a dizzy status; however, the player character may recover by receiving attack from the other player character.

The users may expect the other player character to attack the users' player character in a similar way as the snowman status or the sleeping status.

As explained here above, according to the present embodiment, after storing the sending out condition and the messages in the game data storing unit 58 by associating to each other, when the condition determination unit 54 determines that the sending out condition has been met, it is possible to notify the users' status more certainly to the other users by the communication unit 55 sending the message associated to the sending out condition to the other users and by the drawing process unit 56 displaying the message on the chat field.

Icons may also indicate the player character's status; however, it is more certain to use the message than the icon to notify the other users of the present status, since the majority of the users definitely confirm the chat field when there is a new message displayed on the chat field.

### INDUSTRIAL APPLICABILITY

As explained here above, it is possible to notify the other user of the play character's own status more certainly in accordance with an embodiment.

1. A game device comprising:
a display unit displaying a game screen,
an operation unit inputting an operation of a first user,
a storing unit storing the data,
a virtual space generation unit generating a virtual game space:
a player character control unit controlling within the game space a first player character based on operation information inputted by a user using operation unit; and controlling the second player character within the game space based on received control information of a second player character operated by other user;
a message storing unit containing a predetermined conditions and a message by associating them to each other, into the storing unit
a judgement unit determining whether the predetermined conditions are met,
a message sending unit sending messages to other users and to retrieve the message associated to the predetermined conditions from the storing unit when the judgement unit decides that the predetermined conditions have been met; and
a message displaying unit displaying the message in the display unit sent out by message sending unit and the message received by the other users.

2. The game device according to claim 1, further comprising a message editing unit editing the message based on the users' input and storing the message in the storing unit.

3. The game device according to claim 1,
wherein the message storing unit stores flag information by relating each of the information indicating whether to automatically send the message under the predetermined conditions, and
wherein the message sending unit does not send any messages when the flag information related to the predetermined conditions automatically indicate not to send any messages.

4. The game device according to claim 1,
wherein the predetermined conditions are the change in the status of the first player character or the action of the first player character.

5. A method of controlling a game device including a display unit displaying the game screen, an operation unit inputting an operation of a first user, and a storing unit storing the data, the method comprising:
a step to generate a virtual game space;
a step to control within the game space the first player character based on operation information inputted by the user using the operation unit;
a step to control the second player character within the game space based on received control information of the second player character operated by the other user;
a step to store the predetermined conditions and a message by associating them to each other, into the storing unit;
a step to determine whether the predetermined conditions are met;
a step to send the messages to the other users and to retrieve the message associated to the predetermined conditions from the storing unit when a step to determine decides that the predetermined conditions have been met; and,
a step to display the message sent out and the message received from the other users on the display unit.

6. The method to control the game device according to claim 5,
with a step to edit the message based on the users' input and a step to store the message in the storing unit.

7. The method to control the game device according to claim 5,
wherein the step to store, stores the flag information by relating each of the information indicating whether to automatically send the message under the predetermined conditions, and
wherein the step to send does not send any messages when the flag information related to the predetermined conditions indicate not to automatically send any messages.

8. The method to control the game device according to claim 5,
wherein the predetermined conditions are the change in the status of the first player character or the action of the first player character.

9. A non-transitory computer-readable storage medium storing instructions including a display unit displaying the game screen, an operation unit inputting an operation of a first user and the storing unit storing the data for causing a computer to execute:
a process to generate a virtual game space;
a process to control within the game space the first player character based on the operation information inputted by the first user using the operation unit;
a process to control the second player character within the game space based on received control information of the second player character operated by the other user;
a process to store the predetermined conditions and the message by associating them to each other, into the storing unit;
a process to determine whether the predetermined conditions are met;
a process to send the messages to the other users and to retrieve the message associated to the predetermined conditions from the storing unit when a process to determine decides that the predetermined conditions have been met;
a process to display the message sent out and the message received from the other users on the display unit.

10. The non-transitory computer-readable storage medium storing instructions for causing a computer to execute according to claim 9, with a process to edit the message based on the users' input and a process to store the message in the storing unit.

11. The non-transitory computer-readable storage medium according to claim 9;
wherein the process to store, stores the flag information by relating each of the information indicating whether to automatically send the message under the predetermined conditions, and.
wherein the process to send does not send any messages when the flag information related to the predetermined conditions indicate not to automatically send any messages.

12. The non-transitory computer-readable storage medium according to claim 9;
wherein the predetermined conditions are the change in the status of the first player character or the action of the first player character.
